(19) United States
(12) Patent Application Publication
(10) Pub. No.: US 2022/0223947 A1
(43) Pub. Date: Jul. 14, 2022

(54) PUNCTURE RESISTANT SHIELD OF A BATTERY CONTAINMENT SYSTEM

(71) Applicant: Continental Structure Plastics, Inc., Auburn Hills, MI (US)

(72) Inventors: Hugh Foran, Auburn Hills, MI (US); Patrick Durham, Auburn Hills, MI (US); Masatomo Teshima, Auburn Hills, MI (US)

(73) Assignee: Continental Structure Plastics, Inc., Auburn Hills, MI (US)

(21) Appl. No.: 17/463,715

(22) Filed: Sep. 1, 2021

Related U.S. Application Data
(60) Provisional application No. 63/047,945, filed on Jul. 3, 2020.

(51) Int. Cl. H01M 50/131; H01M 50/145; H01M 50/121; H01M 50/119; H01M 50/143; B60K 1/04

(52) U.S. Cl. CPC H01M 50/131; H01M 50/145; H01M 50/121; H01M 2220/20; H01M 50/143; B60K 1/04; H01M 50/119

(57) ABSTRACT

A puncture resistant shield is provided for use with a battery containment system that is light weight and resistant to corrosion, while improving the safety performance of the battery containment system by providing greater impact and impalement protection as compared to conventional vehicle components. The puncture resistant shield also has utility in that it may be used with existing battery containment systems as an aftermarket installation to increase protection of the batteries contained therein or may be designed for use with new manufactured battery containment systems.

### CROSS REFERENCE TO RELATED APPLICATIONS

This application claims priority benefit of U.S. Provisional Application Ser. No. 63/047,945 filed 3 Jul. 2020, the contents of which are hereby incorporated by reference.

### FIELD OF THE INVENTION

The present invention in general relates to a high strength, light weight battery containment system and in particular to a high strength, light weight puncture resistant shield of such a containment system that provides additional protection to the containment system from road debris.

### BACKGROUND OF THE INVENTION

Weight savings in the automotive, transportation, aerospace, and logistics-based industries has been a major focus in order to make more fuel-efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for reasons that include materials which are stronger, lighter, or less expensive when compared to traditional materials of steel or aluminum. Still another advantage over metals is reduced corrosion, leading to longer operational life and reduced maintenance costs.

Composites typically have two constituent materials: matrix and reinforcement. The matrix material surrounds and supports the reinforcement materials by maintaining their relative positions. The reinforcements impart their special mechanical and physical properties to enhance the matrix properties. A synergism produces material properties unavailable from the individual constituent materials, while the wide variety of matrix and strengthening materials allows the designer of the product or structure to choose an optimum combination.

The use of fiber inclusions to strengthen a matrix is well known to the art. Well established mechanisms for the strengthening of a matrix include slowing and elongating the path of crack propagation through the matrix, as well as energy distribution associated with pulling a fiber free from the surrounding matrix material. In the context of sheet molding composition (SMC) formulations, bulk molding composition (BMC) formulations, and resin transfer molding (RTM) fiber strengthening has traditionally involved usage of chopped glass fibers, while carbon fibers are known to be high strength and low weight reinforcements.

Weight savings are particularly important for electric and hybrid vehicles powered with energy cells employing battery technologies in order to achieve greater vehicle driving range per charge. However, unique problems associated with some components of electric and hybrid vehicles have hindered the ability to use composite materials for some applications on hybrid or electric vehicles. For example, batteries of electric and hybrid vehicles present unique safety considerations owing to the high voltages of the batteries, chemicals employed in the battery technologies, combustion and fire risks associated with the batteries, and potential fume encounters if the batteries are broken or damaged. Therefore, batteries of electric and hybrid vehicles generally require protective containers designed to shield batteries from forces they may otherwise experience during an impact or crash event.

Generally, such protective containers are high strength boxes formed of welded metals, which are heavy, prone to corrosion, and have been found to be water penetrable at least at the welds. Attempts have been made to form protective battery containers from composite materials to reduce the weight of such containers. However, such containers are usually joined with metal bolts, which require additional machining of through holes in the composite material of the container, which is difficult because of the high strength of the material through which the holes must be drilled, placement of the bolts in the through holes, and securing of the bolts with nuts, leading to complex manufacturing techniques, slow manufacturing throughputs, and high manufacturing costs. Additionally, the designs of typical battery containment boxes are generally focused on protecting batteries from side impact forces they may experience during an impact or crash event, while failing to provide sufficient protection of the batteries contained therein from other potential damage such as an impact or impalement of road debris during normal operating conditions.

Thus, there exists a need for a puncture resistant shield for use with a battery containment system that is light weight and resistant to corrosion, while improving the safety performance of the battery containment system by providing greater impact and impalement protection as compared to conventional vehicle components.

### SUMMARY OF THE INVENTION

A puncture resistant shield is provided for use with a battery containment system of a vehicle. The puncture resistant shield includes a shield body portion configured to underlie the battery containment system, where the shield body portion has a first surface and an oppositely opposed second surface both bounded by a first end and a second end and a first side and a second side that each extend from the first end to the second end. A first ramp extends from the first end of the shield body portion at a first angle. The puncture resistant shield is configured to be attached to the battery containment system.

### BRIEF DESCRIPTION OF THE DRAWINGS

The present invention is further detailed with respect to the following drawings that are intended to show certain aspects of the present invention but should not be construed as a limit on the practice of the present invention.

FIG. 1 is a top perspective view of a puncture resistant shield according to embodiments of the present invention attached to a battery containment system;

FIG. 2 is a bottom perspective view of the puncture resistant shield attached to the battery containment system of FIG. 1;

FIG. 3 is a top view of the puncture resistant shield attached to the battery containment system of FIG. 1;

FIG. 4 is a cross sectional view of the puncture resistant shield attached to the battery containment system cut along line 4-4 of FIG. 3;

FIG. 5 is a detailed view of the puncture resistant shield attached to the battery containment system as shown in section 5 of FIG. 4;

FIG. 6 is a cross sectional view of the puncture resistant shield attached to the battery containment system cut along line 6-6 of FIG. 3;

FIG. 7 is a cross sectional view of the puncture resistant shield attached to the battery containment system cut along line 7-7 of FIG. 3;

FIG. 8 is an exploded perspective view of a puncture resistant shield according to embodiments of the present invention and a battery containment system;

FIG. 9 is a cross sectional view of the puncture resistant shield assembled with the battery containment system of FIG. 8;

FIG. 10 is a cross sectional view of a puncture resistant shield according to embodiments of the present invention assembled with a cover of a battery containment system;

FIG. 11A is a bottom view of a cover of a battery containment system to which a shield of the present invention may be attached;

FIG. 11B is a top view of a shield according to embodiments of the present invention;

FIG. 12A is a bottom view of a cover of a battery containment system to which a shield of the present invention may be attached;

FIG. 12B is a top view of a shield according to embodiments of the present invention;

FIG. 13A is a bottom view of a shield according to embodiments of the present invention assembled with a battery containment system;

FIG. 13B is a bottom view of a shield according to embodiments of the present invention assembled with a battery containment system;

FIG. 13C is a bottom view of a shield according to embodiments of the present invention assembled with a battery containment system; and

FIGS. 14A-14D are side views of joiner clips used to attach a shield to a battery containment system according to embodiments of the present invention.

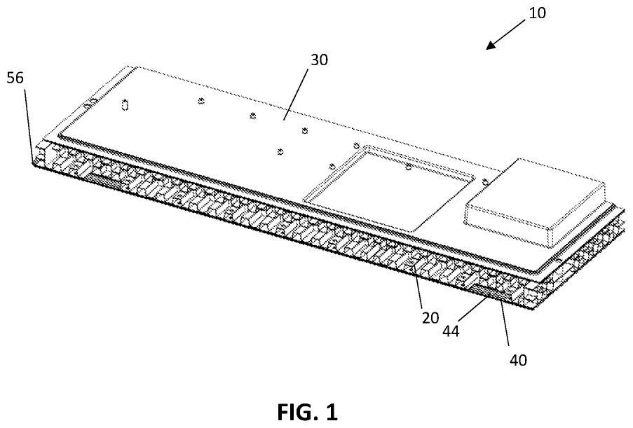

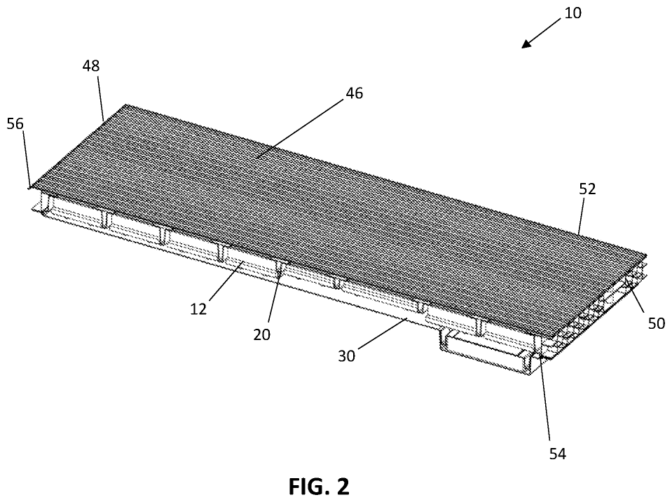

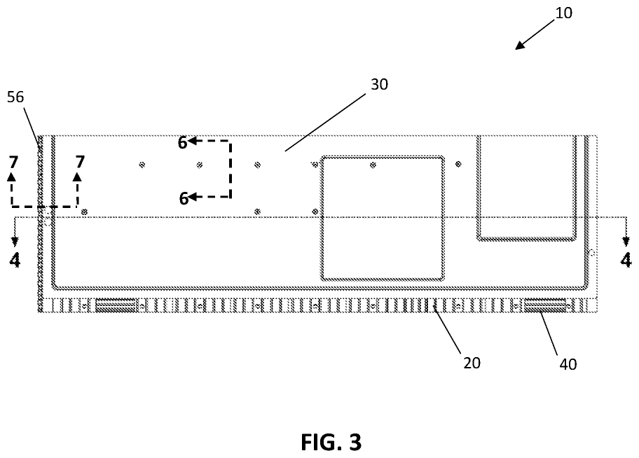

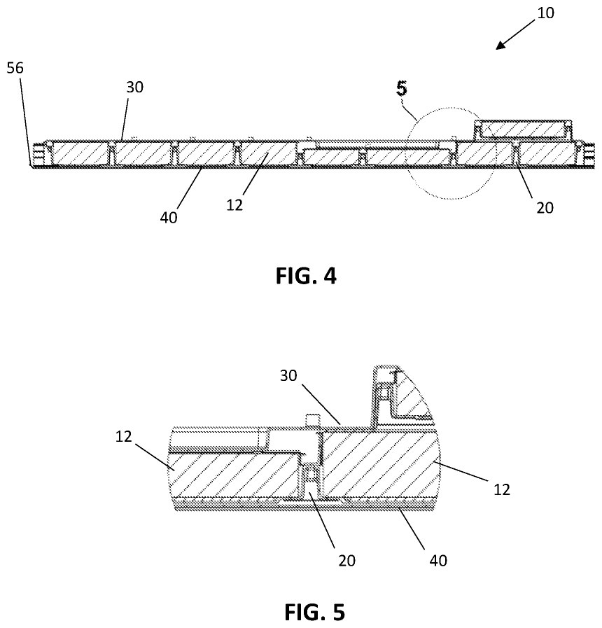

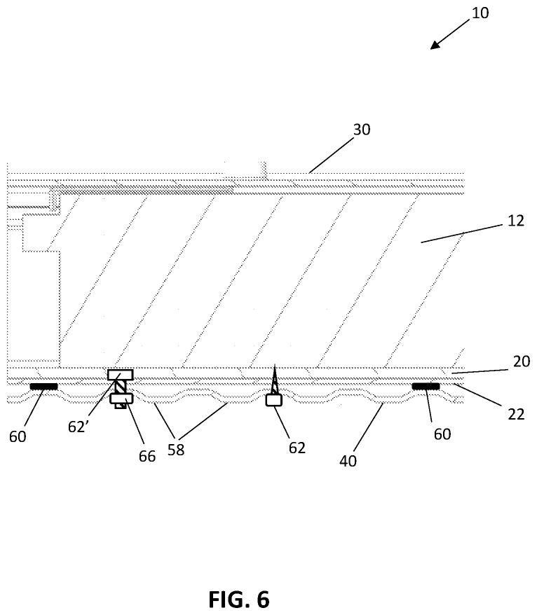

### DESCRIPTION OF THE INVENTION

The present invention has utility as a puncture resistant shield for use with a battery containment system that is light weight and resistant to corrosion, while improving the safety performance of the battery containment system by providing greater impact and impalement protection as compared to conventional vehicle components. The inventive puncture resistant shield also has utility in that it may be used with existing battery containment systems as an aftermarket installation to increase protection of the batteries contained therein or may be designed for use with new manufactured battery containment systems.

Battery cases and containment systems are getting bigger year by year due to the increase in amount of batteries installed. For example, the length of a typical battery case in a vehicle width direction is often 70% or more with respect to the vehicle width, and sometimes 80% or more. For this reason, when a large battery case is mounted in the lower part of the vehicle, a larger load is input to the battery case at the time of a collision rather than previous battery cases. Given the position and size of a battery case on vehicles, the batteries are susceptible to impalement from road or collision debris. Therefore, according to embodiments, the inventive penetration resistant shield is designed to be used with a battery containment case or system to provide resistance to such impalements in order to protect the batteries.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below. As used in the description of the invention and the appended claims, the singular forms “a,” “an” and “the” are intended to include the plural forms as well, unless the context clearly indicates otherwise. Also as used herein, “and/or” refers to and encompasses any and all possible combinations of one or more of the associated listed items, as well as the lack of combinations when interpreted in the alternative (“or”).

Referring now to the figures, a puncture resistant shield 40 for use with a battery containment system 10 of a vehicle is shown. According to embodiments, the puncture resistant shield 40 includes a shield body portion 42 that has a first surface 44 and an oppositely opposed second surface 46 both bounded by a first end 48 and a second end 50 and a first side 52 and a second side 54 that each extend from the first end 48 to the second end 50. The puncture resistant shield 40 additionally includes a first ramp 56 extending from the first end 48 of the shield body portion 42 at a first angle α, which according to embodiments is an angle of 10 to 90 degrees. The puncture resistant shield 40 is configured to be attached to the battery containment system 10 such that the shield body portion 42 underlies the battery containment system 10.

As shown in the figures, a battery containment system 10 with which embodiments of the inventive puncture resistant shield 40 are used generally includes a tray 20 for containing a plurality of batteries 12 and a cover 30. Further details regarding features of a battery containment system 10 are described in co-pending International Patent Application No. PCT/US2020/031750, which is hereby incorporated by reference and are additionally described in part herein.

According to embodiments, the ramp 56 that extends from the first end 48 of the shield body portion 42 is integrally formed with the shield body portion 42. According to embodiments, the ramp 56 extends the entire length of the first end 48 of the shield body portion 42, and therefore the ramp 56 extends from the first end 48 of the shield body portion 42 from the first side 52 to the second side 54 of the shield body portion 42. According to embodiments, the puncture resistant shield 40 is configured to be attached to a battery containment system 10 such that first ramp 56 is positioned towards a front of the vehicle. According to embodiments, first ramp 56 is configured to be angled upwards towards said battery containment system 10 when said puncture resistant shield 40 is attached to the battery containment system 10. Such positioning and orientation of the first ramp 56 of the shield 40 allows the ramp 56 to further protect batteries 12 contained in the containment system 10 by deflecting road and crash debris that the vehicle may encounter when traveling in a forward direction. According to embodiments, the shield 40 additionally includes at least one additional ramp 56′ extending from at least one of the second end 50, the first side 52, and the second side 54 of the shield body portion 42 at a second angle β, which according to embodiments is the same angle as the first angle α.

According to certain inventive embodiments, the shield 40 is formed of reinforced sheet molding compound (SMC), a phenolic-SMC, epoxy, acrylonitrile butadiene styrene (ABS), polycarbonate, random-oriented fiber reinforced thermoplastic resin (FRTP), steel, or aluminum. Sheet molding compound (SMC) or sheet molding composite is a ready to mold fiber-reinforced polyester material primarily used in compression molding. SMC is a reinforced composite material that is manufactured by dispersing long strands (20-60 mm) of chopped glass fibers in a matrix of polyester resin. It is appreciated that fibers with long range order are also operative herein and include woven mats, continuous fibers, or sheet forms. Thermoplastic materials operative herein amenable to functioning as a fiber matrix illustratively include: poly(methyl methacrylate) (PMMA), acrylonitrile butadiene styrene (ABS), polyamides, polylactides, polybenzimidazoles, polycarbonates, polyether sulfones, polyethylene, polypropylene, polystyrene, polyvinyl chloride, or block copolymers of any one of the aforementioned constituting the majority by monomer number. Reinforcing fibers and fillers operative herein illustratively include carbon fibers, glass fibers, aramid fibers, cellulosic fibers, or a combination thereof. In some inventive embodiments, the chopped fiber is glass fiber, alone or in combination with other types of fiber or reinforcing fillers. According to embodiments, the shield 40 is formed of aramid fiber reinforced SMC, which is particularly well suited for resisting impalement by crash or road debris.

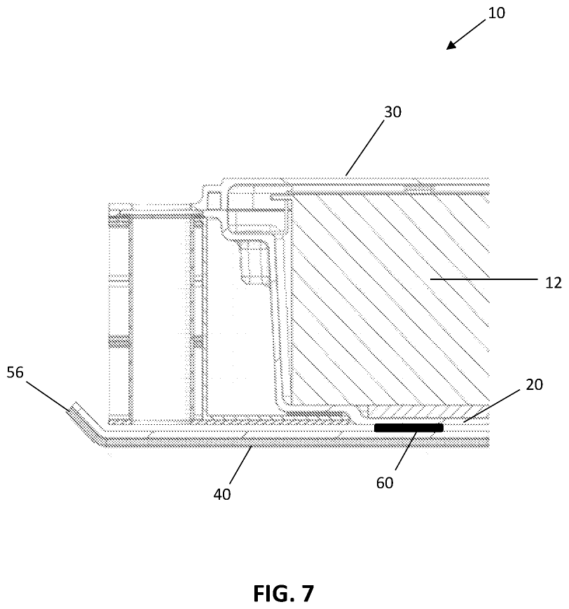

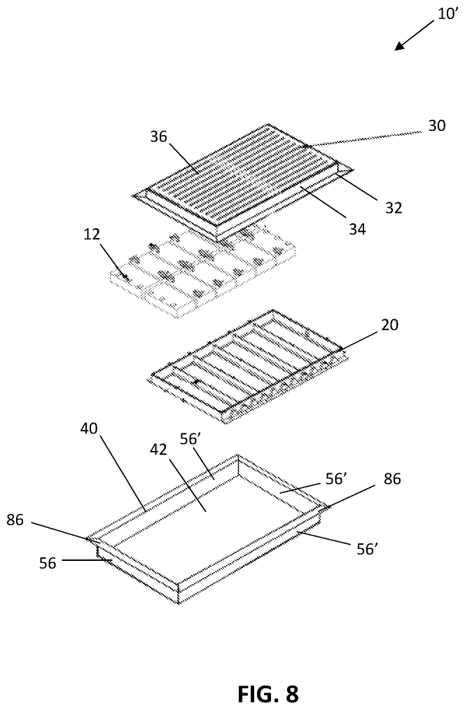

As shown in FIG. 6, according to embodiments, the puncture resistant shield 40 is formed to have corrugations 58. According to embodiments, the corrugations 58 have a repeating shape of any of: an open semi hexagon, an open semi-circle, an open semi oval, an open triangle, an open semi square, an open semi rectangle, or a sine wave. According to embodiments, the corrugations are formed in the material of the shield 40 by a stamping process, a bending process, or by a molding process.

According to embodiments, the shield 40 may have one or more coatings. The coating illustratively includes materials that impart fire resistance, are phenolic in nature, electromagnetic interference-radiofrequency interference (EMI-RFI) resistance, or a combination of such coatings. It is appreciated that coating as used in this context is intended to include separate layers of material that are applied as a sheet material to a substrate of the shield 40. That is, according to embodiments, the shield 40 is coated in a fire resistant, or a fire-retardant material. A fire-resistant material is one that is designed to resist burning and withstand heat and provide insulation to the substrate, while a fire-retardant material is designed to burn slowly and reduce the rate of flame spread. Intumescent fire-resistant materials work by expanding their volume from 15 to 30 times and generating an ash-like char layer that erodes as fire exposure continues. Expansion then occurs again with the number of times the process repeats itself dependent upon the thickness of the coating. For example, such fire resistant or fire retardant materials for coating the shield 40 include any of the following: silicone, casein or vinyl resins, aluminum trihydrate or antimony oxide, ammonium polyphosphate, pentaerythritol, melamine derivatives, boric acid (H₃BO₃) and borax (Na₂B₄O₇.10H₂O), disodium octaborate tetrahydrate (Na₂B₈O₁₃.4H₂O), dicyandiamide-formaldehyde-phosphoric acid, melamine-dicyandiamide-formaldehyde-phosphoric acid, poly(n-vinylpyrolidone), colloidal silica, magnesium hydroxide (MDH), monoammonium phosphate (MAP), aluminum hydroxide (ATH), carbonates and hydrogen carbonates, potassium carbonate, Na₂WO₄, Na₂SnO₃, Na₂MoO₄, ammonium polyphosphate, pentaerythritol, melamine, expandable graphite, or combinations thereof. Phenolic resins operative herein illustratively includes epoxy phenolic resins, and phenol formaldehyde resins that impart corrosion resistance and a mar resistance surface relative to the underlying substrate of the shield 40. EMI-RFI shielding coatings operative herein illustratively include nickel coated glass mat; carbon fiber matting; copper or nickel paint; various metal foils, such as aluminum, nickel, iron, copper, and alloys thereof; and or combinations thereof with the proviso that the EMI-RFI shielding is grounded so as to function as a Faraday cage. It is further appreciated that coatings in the form of sheets are readily applied as an underlying sheet below an inventive shield 40 or are included as filler in the materials that are used to form the shield 40.

According to embodiments, the puncture resistant shield 40 is configured to be attached to the battery containment system 10 using an adhesive 60 applied between the first surface 44 of the shield body portion 42 and a lower surface 22 of the battery containment system 10, which for example is the lower surface of the tray 20. According to embodiments, the puncture resistant shield 40 is configured to be attached to the battery containment system 10 by a plurality of fasteners 62, 62′ that extend through said shield body portion 42 through a plurality of through holes formed in said shield body portion 42. According to embodiments, such through holes may be formed in the material of the shield body portion 42 when the SMC material is laid up or may be formed subsequently by a drilling or stamping process. The plurality of fasteners 62 for example may include screws or bolts that are inserted through the shield body portion 42 such that the threaded end is secured within the battery containment system 10. Alternatively, the plurality of fasteners 62′ for example may include bolts that have their heads embedded in the battery containment system and their threads exposed downward for insertion through the holes 64 formed in the shield body portion 42. In such an instance, nuts 66 or other suitable securing devices are installed onto the threaded portions of the embedded bolts 62′ to secure the shield 40 to the battery containment system 10.

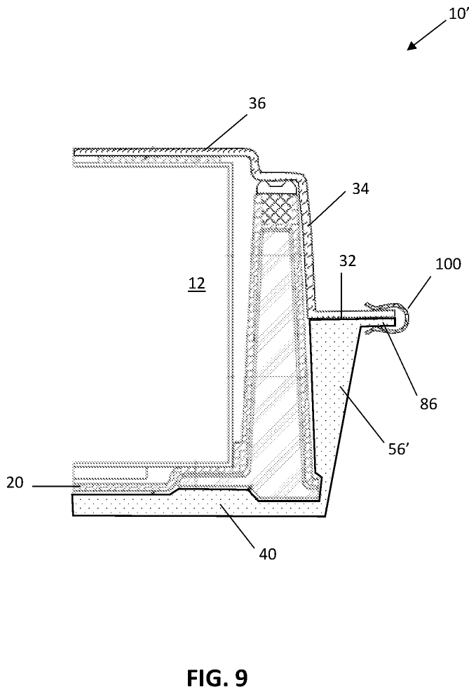

According to embodiments such as that shown in FIGS. 8-13, the shield 40 additionally includes a shield flange 86 that extends from the shield body portion 42. As shown in FIG. 8, the shield body portion 42 of the shield 40 may include a plurality of ramps 56, 56′ from which the shield flange 86 extends such that the flange and the shield body portion 42 are in separate planes. According to embodiments, the flange 86 of the shield 40 extends from the shield body portion 42 such that the shield 40 is a substantially planar component. As noted above, shield body portion 42 of the shield 40 is configured to underlie the tray 20 of the battery containment system 10. The flange 86 of the shield 40, which extends from the shield body portion 42 or from the ramp 56 or additional ramp 56′, is configured to extend beyond the tray 20 of the battery containment system 10. Additionally, the flange 86 of the shield 40 is configured to engage a flange 32 of the cover 30 of the battery containment system 10.

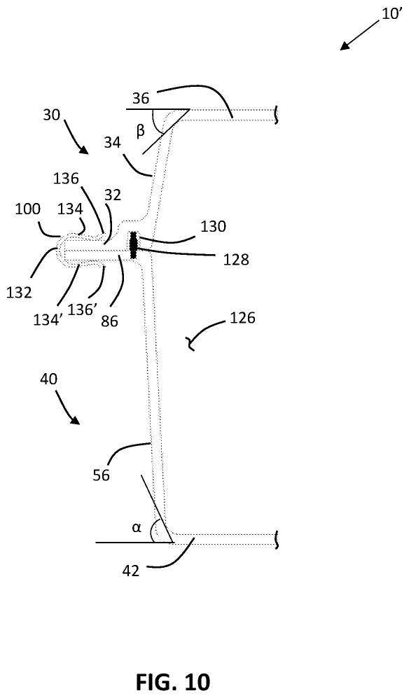

As shown in FIG. 8, the cover 30 includes wall 34 between the cover flange 32 and the cover body portion 36, making the cover flange 32 and the cover body portion 36 in different planes. The shield 40 is positioned under the tray 20. As shown in FIG. 8, the shield 40 includes ramps 56, 56′ that extend from the first end 48, second end 50, first side 52, and second side 54 of the body portion 42 of the shield 40 and from which the shield flange 86 extends. The cover flange 32 and the shield flange 86 are configured to engage one another in an abutting relationship and be joined together by a joiner clip 100, as shown in FIG. 9.

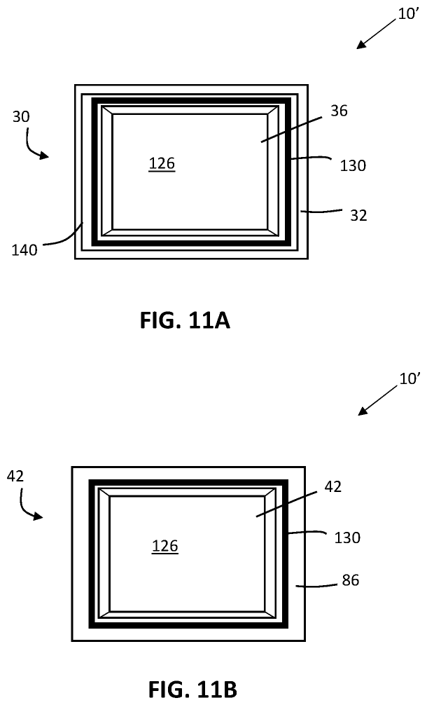

FIG. 10 shows a cross sectional view of a cover 30 of a battery containment system 10 and a shield 40 of the present invention joined together by a joiner clip 100. In FIG. 10, the tray 20 and batteries 12 of the battery containment system 10 is not shown for clarity. As shown, a joiner clip 100 having a C-shaped cross section joins the cover 30 and the shield 40 together. The cover 30, the shield 40, and the joiner clip 100 are configured to be assembled around the tray 20 of a battery containment system 10 in such a way as to attach the inventive shield 40 to the containment system 10. The puncture resistant shield 40 thereby provides impalement resistance, impact resistance to the battery containment system 10 and the batteries 12 contained therein.

According to embodiments, the flange 32 of the cover and the shield flange 86 of the shield 40 are configured to engage one another in abutting contact such that the cover 30 and the shield 40 define a cavity 126 therebetween. The cavity 126 is configured to receive and contain the tray 20, as described above. The joiner clip 100 is configured to engage the cover flange 32 and the shield flange 86 to join the cover 30 and the shield 40 together.

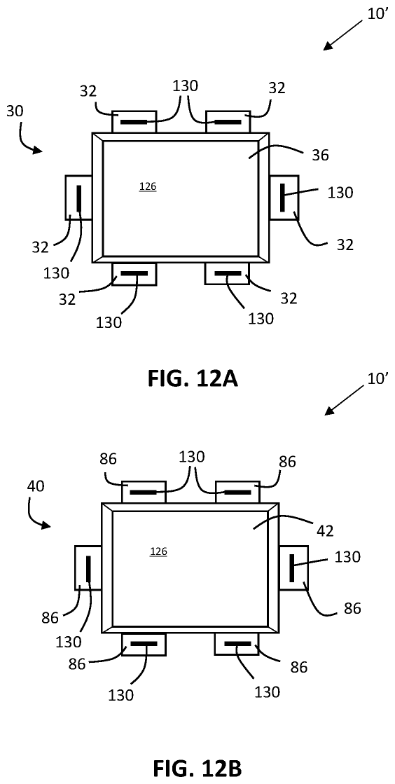

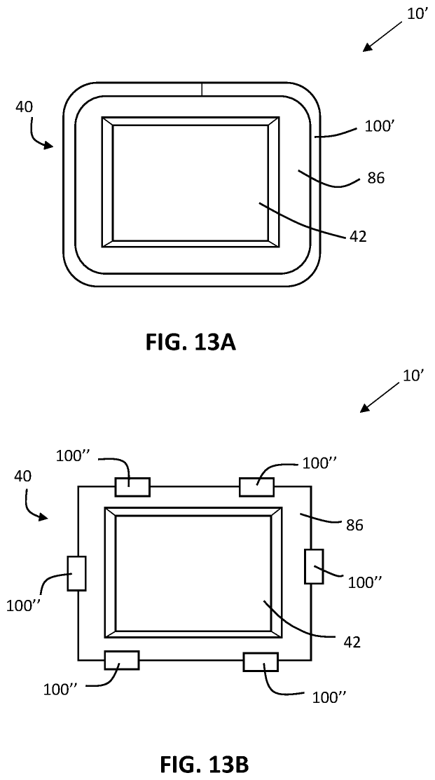

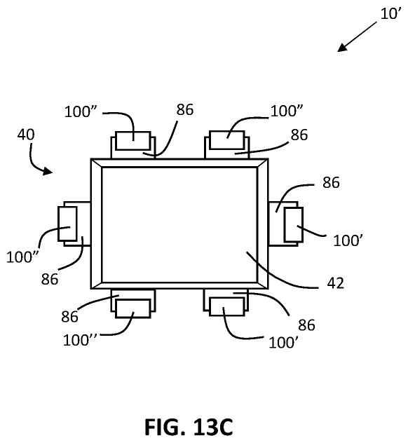

According to embodiments, the cover flange 32 surrounds the perimeter of the cover 30. Similarly, according to embodiments, the shield flange 86 surrounds the perimeter of the shield 40. According to embodiments, such as those shown in FIGS. 11A, 11B, 13A, and 13B, the flanges 32, 86 are each continuous in that they entirely cover the perimeter of the cover 30 and shield 40, respectively. According to other embodiments, such as those shown in FIGS. 12A, 12B, and 13C, the flanges 32, 86 are each made up of separate and discrete flange portions that non-continuously surround the cover 30 and shield 40, respectively. According to embodiments, in which the flanges 32, 86 are continuous and entirely surround the cover 30 and shield 40, the joiner clip 100 is either a single continuous joiner clip 100′, as shown in FIG. 13A, that also entirely surrounds the cover 30 and shield 40, or the joiner clip is a plurality of separate and discrete joiner clips 100″, as shown in FIG. 13B, positioned at separate locations along the cover flange 32 and the shield flange 86 to non-continuously surround the cover 30 and the shield 40. According to embodiments, in which the flanges 32, 86 are each made up of separate and discrete flange portions that non-continuously surround the respective cover 30 and shield 40, the joiner clip 100 is a plurality of separate and discrete joiner clips 100″ positioned at separate locations along the cover flange 32 and the shield flange 86 to non-continuously surround the cover 30 and shield 40, as shown in FIG. 13C.

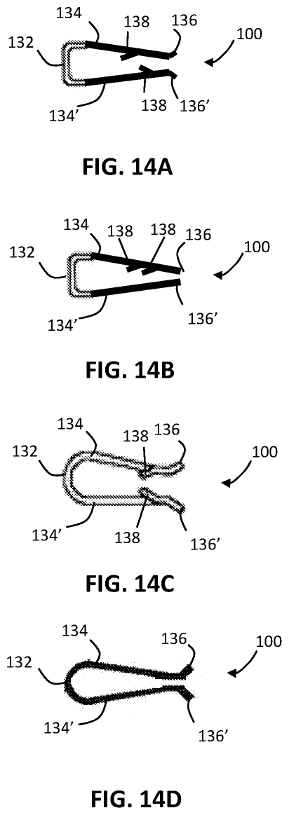

As shown in FIGS. 10 and 14A-14D, the joiner clip 100 includes a base section 132 and a pair of jaws 134, 134′extending from the base 132 section each jaw 134, 134′ of the pair of jaws having a free end 136, 136′, respectively. According to embodiments, the base section 132 is curved or square, as shown in FIGS. 14C-14D and 14A-14B, respectively. According to embodiments, one or both of the jaws 134, 134′ are straight or feature a curve such that the free ends 136, 136′ of each of the jaws 134, 134′ are flared away from one another, such as shown in FIGS. 14A and 14C-14D and 14B, respectively. The flared free ends 136, 136′ facilitate easy application of the joiner clip 100 onto the flanges 32, 86. That is, to apply the joiner clip 100, the flanges 32, 86 are positioned between the free ends 136, 136′ of the joiner clip and the joiner clip 100 is pushed or pounded onto the flanges 32, 86, thereby eliminating the need for a special tool for separating the jaws 134, 134′. The flared free ends 136, 136′ also reduce wear on the composite material of the flanges 32, 86 by ensuring that the free ends 136, 136′ do not rub on the flanges 32, 86.

According to embodiments, the free ends 136, 136′ of each of the jaws 134, 134′ are biased toward one another. Thus, when the joiner clip 100 is engaged with the flanges 32, 86, such that the flanges 32, 86 are positioned between the jaws 134, 134′ of the joiner clip 100, the joiner clip applies a compressive force to the cover flange 32 and the shield flange 86 to join the cover 30 and the shield 40 together. According to embodiments, the joiner clip is formed of a metal, such as spring steel, a thermoplastic, or an elastomeric material. Embodiments in which the joiner clip is formed of an elastomeric material provide the additional benefit of sealing the cover 30 and shield 40 while also joining them together. According to embodiments, the joiner clip 100 also includes at least on barb 138 positioned on an inner surface of at least one of the jaws 134, 134′. The barb or barbs 138 are configured to dig into the composite material of the flanges 32, 86 or may engage with a groove 140 formed in the flanges to prevent the joiner clip 100 from falling off of or being easily removed from the flanges 32, 86.

According to embodiments, the shield 40 also includes a barrier material 128 positioned between the cover flange 32 and the shield flange 86. According to embodiments, the barrier material 128 acts as a seal and/or a connector between the cover 30 and the shield 40 to limit movement or slippage between the cover 30 and the shield 40. According to embodiments, the barrier material 128 is any of an adhesive, a gasket, or a connector. In some embodiments, such as that shown in FIG. 10, at least one of the cover flange 32 and shield flange 86 define a channel 130 that is configured to receive and retain the barrier material 128. The channel 130 may be a continuous channel or may be a plurality of discrete channels spaced along the length of the flanges 32, 86 at spaced apart positions. According to embodiments in which at least one of the flanges 32, 86 includes a channel, the barrier material 128 is placed in the channel 130 before the flanges 32, 86 are brought into contact with one another. According to embodiments, in which both flanges 32, 86 define a channel 130 therein, the barrier material 128 is placed in the channel 130 of for example the cover flange 32 and then the shield flange 86 is brought into contact with the cover flange 32 and the barrier material. In such embodiments, the barrier material 128 can be used as a position locator for ensuring that the cover flange 32 and shield flange 86 are properly positioned relative to one another. Additionally, once assembled, the barrier material 128 ensures that the cover 30 and the shield 40 remain properly positioned relative to one another during use, by preventing slippage, which in turn reduces wear on the parts. It will also be understood that when the barrier material 128 is a gasket, the barrier material may act to seal the cover 30 and shield 40 in water tight engagement and act to locate and retains the cover 30 and shield 40 relative to one another.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. A puncture resistant shield for use with a battery containment system of a vehicle, said puncture resistant shield comprising:
a shield body portion configured to underlie the battery containment system, said shield body portion having a first surface and an oppositely opposed second surface both bounded by a first end and a second end and a first side and a second side that each extend from the first end to the second end; and
a first ramp extending from the first end of said shield body portion at a first angle;
wherein said puncture resistant shield is configured to be attached to said battery containment system.

2. The puncture resistant shield of claim 1 wherein said shield is formed of metal or reinforced SMC.

3. The puncture resistant shield of claim 2 wherein the SMC is reinforced with carbon fibers, glass fibers, aramid fibers, cellulosic fibers, or a combination thereof.

4. The puncture resistant shield of claim 1 wherein said shield is coated in a fire resistant or phenol coating.

5. The puncture resistant shield of claim 1 wherein said shield provides EMI-RFI shielding to components contained in said battery containment system.

6. The puncture resistant shield of claim 1 wherein said puncture resistant shield is formed to have corrugations.

7. The puncture resistant shield of claim 6 wherein the corrugations have a repeating shape of any of: an open semi hexagon, an open semi-circle, an open semi oval, an open triangle, an open semi square, an open semi rectangle, or a sine wave.

8. The puncture resistant shield of claim 1 wherein said first ramp is integrally formed with said shield body portion.

9. The puncture resistant shield of claim 1 wherein said first ramp extends from the first end of said shield body portion at an angle of 45 degrees.

10. The puncture resistant shield of claim 1 wherein said first ramp extends from the first end of said shield body portion along the entire length of the first end of said shield body portion.

11. The puncture resistant shield of claim 1 wherein said first ramp is configured to be angled upwards towards said battery containment system when said puncture resistant shield is attached to the battery containment system.

12. The puncture resistant shield of claim 1 wherein said first ramp is configured to be positioned towards a front of the vehicle when said puncture resistant shield is attached to the battery containment system.

13. The puncture resistant shield of claim 1 further comprising at least one additional ramp extending from at least one of the second end, the first side, and the second side of said shield body portion at a second angle.

14. The puncture resistant shield of claim 13 wherein the second angle is the same as the first angle.

15. The puncture resistant shield of claim 1 wherein said puncture resistant shield is configured to be attached to said battery containment system by an adhesive between the first surface of said shield body portion and a lower surface of said battery containment system.

16. The puncture resistant shield of claim 1 wherein said puncture resistant shield is configured to be attached to a lower surface of said battery containment system by a plurality of fasteners that extend through said shield body portion.

17. The puncture resistant shield of claim 1 further comprising a first flange extending from any of the first end, the second end, the first side, and the second side of said shield body portion, said first flange configured to engage a second flange of said battery containment system.

18. The puncture resistant shield of claim 17 further comprising a joiner clip configured with a C-shaped cross section to engage the first flange and the second flange to attach said puncture resistant shield to said battery containment system.
